(19) United States
(12) Patent Application Publication
(10) Pub. No.: US 2013/0038410 A1
(43) Pub. Date: Feb. 14, 2013

(54) Thermally Conductive Stripline RF Transmission Cable

(71) Applicants: Kendrick Van Swearingen, Woodridge, IL (US); Jeffrey D. Paynter, Momence, IL (US); Alan Neal Moe, Hickory, NC (US); Ronald Alan Vaccaro, Shorewood, IL (US); Frank A. Harwath, Naperville, IL (US)

(72) Inventors: Kendrick Van Swearingen, Woodridge, IL (US); Jeffrey D. Paynter, Momence, IL (US); Alan Neal Moe, Hickory, NC (US); Ronald Alan Vaccaro, Shorewood, IL (US); Frank A. Harwath, Naperville, IL (US)

(73) Assignee: ANDREW LLC, Hickory, NC (US)

(21) Appl. No.: 13/570,856

(22) Filed: Aug. 9, 2012

Related U.S. Application Data
(63) Continuation-in-part of application No. 13/427,313, filed on Mar. 22, 2012.
Application No. 13/427,313 is a continuation-in-part of application No. 13/208,443, filed on Aug. 12, 2011.

(51) Int. Cl. H01P 3/08

(52) U.S. Cl. 333/238

(57) ABSTRACT

A thermally conductive stripline RF transmission cable has a flat inner conductor surrounded by a dielectric layer that is surrounded by an outer conductor. The dielectric layer may include a base polymer and a thermally conductive material to increase a thermal conductivity of the cable. A thermal conductivity of the dielectric layer may be increased between a midsection of the inner conductor and the outer conductor. A jacket may surround the outer conductor, the jacket including a base polymer and a thermally conductive material. Additional conductors may be applied within the dielectric layer and/or in the jacket, proximate the outer conductor.

### CROSS REFERENCE TO RELATED APPLICATIONS

This application is a continuation-in-part of commonly owned co-pending U.S. Utility Patent Application Ser. No. 13/208,443, titled “Stripline RF Transmission Cable” filed 12 Aug. 2011 by Frank A. Harwath, hereby incorporated by reference in its entirety. This application is also a continuation-in-part of commonly owned co-pending U.S. Utility Patent Application Ser. No. 13/427,313, titled “Low Attenuation Stripline RF Transmission Cable” filed 22 Mar. 2012 by Frank A. Harwath, hereby incorporated by reference in its entirety, which is a continuation-in-part of U.S. Utility Patent Application Ser. No. 13/208,443.

### BACKGROUND

1. Field of the Invention

RF Transmission systems are used to transmit RF signals from point to point, for example, from an antenna to a transceiver or the like. Common forms of RF transmission systems include coaxial cables and striplines.

2. Description of Related Art

Prior coaxial cables typically have a coaxial configuration with a circular outer conductor evenly spaced away from a circular inner conductor by a dielectric support such as polyethylene foam or the like. The electrical properties of the dielectric support and spacing between the inner and outer conductor define a characteristic impedance of the coaxial cable. Circumferential uniformity of the spacing between the inner and outer conductor prevents introduction of impedance discontinuities into the coaxial cable that would otherwise degrade electrical performance.

An industry standard characteristic impedance is 50 ohms. Coaxial cables configured for 50 ohm characteristic impedance generally have an increased inner conductor diameter compared to higher characteristic impedance coaxial cables such that the metal inner conductor material cost is a significant portion of the entire cost of the resulting coaxial cable. To minimize material costs, the inner and outer conductors may be configured as thin metal layers for which structural support is then provided by less expensive materials. For example, commonly owned U.S. Pat. No. 6,800,809, titled “Coaxial Cable and Method of Making Same”, by Moe et al, issued Oct. 5, 2004, hereby incorporated by reference in the entirety, discloses a coaxial cable structure wherein the inner conductor is formed by applying a metallic strip around a cylindrical filler and support structure comprising a cylindrical plastic rod support structure with a foamed dielectric layer therearound. The resulting inner conductor structure has significant materials cost and weight savings compared to coaxial cables utilizing solid metal inner conductors. However, these structures can incur additional manufacturing costs, due to the multiple additional manufacturing steps required to sequentially apply each layer of the structure.

One limitation with respect to metal conductors and/or structural supports replacing solid metal conductors is bend radius. Generally, a larger diameter coaxial cable will have a reduced bend radius before the coaxial cable is distorted and/or buckled by bending. In particular, structures may buckle and/or be displaced out of coaxial alignment by cable bending in excess of the allowed bend radius, resulting in cable collapse and/or degraded electrical performance.

Another consideration of coaxial cables is thermal dissipation. Because the inner conductor is retained coaxially with respect to the outer conductor, typically via a dielectric material with a low thermal conductivity characteristic, heat generated along the inner conductor by high power RF signal transmission may be difficult to disperse, leading to a signal transmission power limitation and/or thermal damage to the coaxial cable. Prior coaxial cable RF transmission system heat dissipation solutions include in-line heat sinks utilizing, for example, a ceramic based thermally conductive dielectric material and/or coaxial cables with dielectric materials with an improved thermal dissipation characteristic. For example, commonly owned U.S. Pat. No. 7,705,238, titled “Coaxial RF Device Thermally Conductive Polymer Insulator and Method of Manufacture”, by Kendrick Van Swearingen, issued 27 Apr. 2010, hereby incorporated by reference in the entirety, discloses a rigid insulator for a coaxial assembly utilizing a thermally conductive polymer composition structure wherein the dielectric material is infused with boron nitride particles, carbon fibers and ceramic particles. However, because the thermally conductive dielectric material disclosed is rigid, use of such thermally conductive dielectric material as the dielectric layer in a coaxial cable may unacceptably reduce a flexibility characteristic of the resulting coaxial cable and/or be prohibitively expensive.

A stripline is a flat conductor sandwiched between parallel interconnected ground planes. Striplines have the advantage of being non-dispersive and may be utilized for transmitting high frequency RF signals. Striplines may be cost effectively generated using printed circuit board technology or the like. However, striplines may be expensive to manufacture in longer lengths/larger dimensions. Further, where a solid stacked printed circuit board type stripline structure is not utilized, the conductor sandwich is generally not self supporting and/or aligning, compared to a coaxial cable, and as such may require significant additional support/reinforcing structure.

Competition within the RF cable industry has focused attention upon reducing materials and manufacturing costs, electrical characteristic uniformity, defect reduction and overall improved manufacturing quality control.

Therefore, it is an object of the invention to provide a coaxial cable and method of manufacture that overcomes deficiencies in such prior art.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic isometric view of an exemplary cable, with layers of the conductors, dielectric spacer and outer jacket stripped back.

FIG. 2 is a schematic end view of the cable of FIG. 1.

FIG. 3 is a schematic isometric view demonstrating a bend radius of the cable of FIG. 1.

FIG. 4 is a schematic isometric view of an alternative cable, with layers of the conductors, dielectric spacer and outer jacket stripped back.

FIG. 5 is a schematic end view of an alternative embodiment cable utilizing varied dielectric layer dielectric constant distribution.

FIG. 6 is a schematic end view of another alternative embodiment cable utilizing varied dielectric layer dielectric constant distribution.

FIG. 7 is a schematic end view of an alternative embodiment cable utilizing cavities for varied dielectric layer dielectric constant distribution.

FIG. 8 is a schematic end view of an alternative embodiment cable utilizing sequential vertical layers of varied dielectric constant in the dielectric layer.

FIG. 9 is a schematic end view of an alternative embodiment cable utilizing dielectric rods for varied dielectric layer dielectric constant distribution.

FIG. 10 is a schematic end view of an alternative embodiment cable utilizing dielectric rods for varied dielectric layer dielectric constant distribution.

FIG. 11 is a schematic end view of an alternative embodiment cable utilizing varied outer conductor spacing to modify operating current distribution within the cable.

FIG. 12 is a schematic end view of another alternative embodiment cable utilizing drain wires for varied outer conductor spacing to modify operating current distribution within the cable.

FIG. 13 is a schematic isometric partial cut-away view of an alternative embodiment of a cable with longitudinally spaced bulkheads of thermally conductive material in the dielectric layer.

FIG. 14 is a schematic isometric partial cut-away view of an alternative embodiment of a cable utilizing varied outer conductor spacing and longitudinally spaced bulkheads of thermally conductive material in the dielectric layer.

FIG. 15 is a schematic isometric partial cut-away view of an alternative embodiment of a cable with thermally conductive material in the dielectric layer aligned vertically between a midsection of the inner conductor and the outer conductor.

FIG. 16 is a schematic end view of FIG. 15.

FIG. 17 is a schematic isometric partial cut-away view of an alternative embodiment of a cable utilizing varied outer conductor spacing and thermally conductive material in the dielectric layer aligned vertically between a midsection of the inner conductor and the outer conductor.

FIG. 18 is a schematic end view of FIG. 17.

FIG. 19 is a schematic isometric partial cut-away view of an alternative embodiment of a cable with thermally conductive material in the jacket aligned vertically with a midsection of the inner conductor.

FIG. 20 is a schematic end view of FIG. 19.

FIG. 21 is a schematic isometric partial cut-away view of an alternative embodiment of a cable utilizing varied outer conductor spacing and thermally conductive material in the jacket aligned vertically with a midsection of the inner conductor.

FIG. 22 is a schematic end view of FIG. 21.

FIG. 23 is a schematic isometric partial cut-away view of an alternative embodiment of a cable with thermally conductive material in the jacket and dielectric layer aligned vertically with a midsection of the inner conductor.

FIG. 24 is a schematic end view of FIG. 23.

FIG. 25 is a schematic isometric partial cut-away view of an alternative embodiment of a cable utilizing varied outer conductor spacing and thermally conductive material in the jacket and dielectric layer aligned vertically with a midsection of the inner conductor.

FIG. 26 is a schematic end view of FIG. 25.

FIG. 27 is a schematic isometric partial cut-away view of an alternative embodiment of a cable with thermally conductive material and an additional conductor in the dielectric layer aligned vertically between a midsection of the inner conductor and the outer conductor.

FIG. 28 is a schematic end view of FIG. 27.

FIG. 29 is a schematic isometric partial cut-away view of an alternative embodiment of a cable utilizing varied outer conductor spacing and thermally conductive material and an additional conductor in the dielectric layer aligned vertically between a midsection of the inner conductor and the outer conductor.

FIG. 30 is a schematic end view of FIG. 29.

FIG. 31 is a schematic isometric partial cut-away view of an alternative embodiment of a cable with thermally conductive material in the dielectric layer aligned vertically between a midsection of the inner conductor and the outer conductor and additional conductors aligned with a horizontal plane of the inner conductor.

FIG. 32 is a schematic end view of FIG. 31.

FIG. 33 is a schematic isometric partial cut-away view of an alternative embodiment of a cable utilizing varied outer conductor spacing and thermally conductive material and an additional conductor in the dielectric layer aligned vertically between a midsection of the inner conductor and the outer conductor and additional conductors aligned with a horizontal plane of the inner conductor.

FIG. 34 is a schematic end view of FIG. 33.

FIG. 35 is a schematic isometric partial cut-away view of an alternative embodiment of a cable with longitudinally spaced bulkheads of thermally conductive material in the dielectric layer in addition to a longitudinal strip of thermally conductive material and additional conductors in the jacket.

FIG. 36 is a schematic end view of FIG. 35.

FIG. 37 is a schematic isometric partial cut-away view of an alternative embodiment of a cable utilizing varied outer conductor spacing and longitudinally spaced bulkheads of thermally conductive material in the dielectric layer in addition to a longitudinal strip of thermally conductive material and additional conductors in the jacket.

FIG. 38 is a schematic end view of FIG. 37.

FIG. 39 is a schematic end view of an alternative embodiment of a cable with a longitudinal strip of thermally conductive material and additional conductors in the jacket.

FIG. 40 is a schematic end view of an alternative embodiment of a cable utilizing varied outer conductor spacing and a longitudinal strip of thermally conductive material and an additional conductor in the jacket.

FIG. 41 is a schematic end view of an alternative embodiment of a cable with a longitudinal strip of thermally conductive material and an additional conductor in the jacket in addition to thermally conductive material in the dielectric layer and additional conductors vertically aligned with a midsection of the inner conductor.

FIG. 42 is a schematic end view of an alternative embodiment of a cable utilizing varied outer conductor spacing and a longitudinal strip of thermally conductive material and an additional conductor in the jacket in addition to thermally conductive material in the dielectric layer and additional conductors vertically aligned with a midsection of the inner conductor.

FIG. 43 is a schematic end view of an alternative embodiment of a cable with a longitudinal strip of thermally conductive material in the jacket and thermally conductive material in the dielectric layer vertically aligned with a midsection of the inner conductor and additional conductors aligned with a horizontal plane of the inner conductor.

FIG. 44 is a schematic end view of an alternative embodiment of a cable utilizing varied outer conductor spacing, a longitudinal strip of thermally conductive material in the jacket and thermally conductive material in the dielectric layer vertically aligned with a midsection of the inner conductor and additional conductors aligned with a horizontal plane of the inner conductor.

### DETAILED DESCRIPTION

The inventors have recognized that the prior accepted coaxial cable design paradigm of concentric circular cross-section design geometries results in unnecessarily large coaxial cables with reduced bend radius, excess metal material costs and/or significant additional manufacturing process requirements.

The inventors have further recognized that the application of a flat inner conductor, compared to a conventional circular inner conductor configuration, enables modification of the coaxial cable to improve a thermal dissipation characteristic of the cable with a reduced trade-off in electrical and/or mechanical performance.

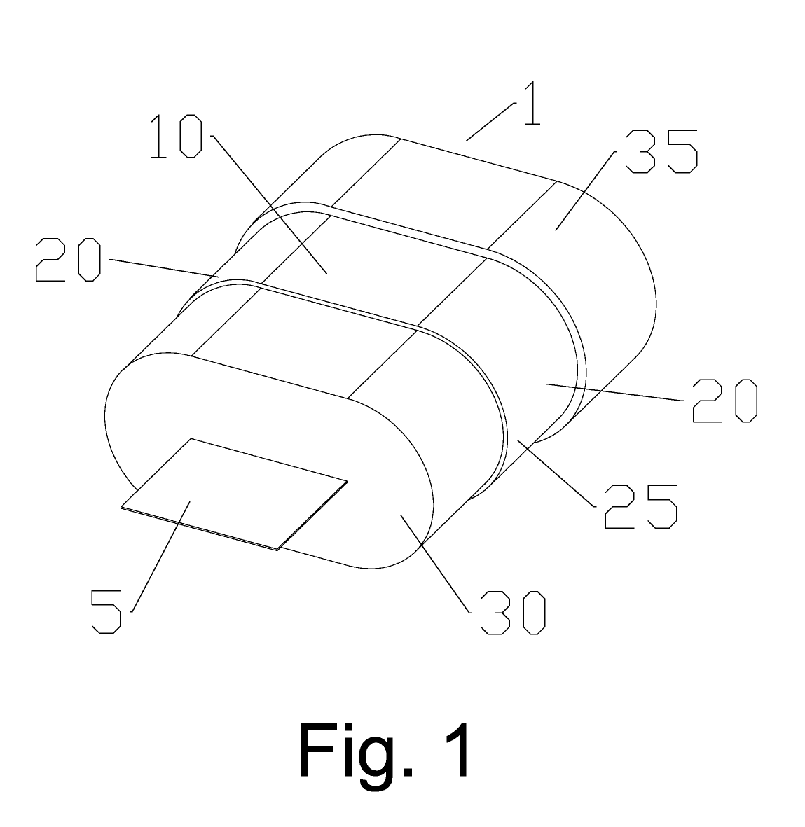

An exemplary stripline RF transmission cable 1 is demonstrated in FIGS. 1-3. As best shown in FIG. 1, the inner conductor 5 of the cable 1, extending between a pair of inner conductor edges 3, is a flat metallic strip. A top section 10 and a bottom section 15 of the outer conductor 25 are aligned parallel to the inner conductor 5 with widths equal to the inner conductor width. The top and bottom sections 10, 15 transition at each side into convex edge sections 20. Thus, the circumference of the inner conductor 5 is entirely sealed within an outer conductor 25 comprising the top section 10, bottom section 15 and edge sections 20.

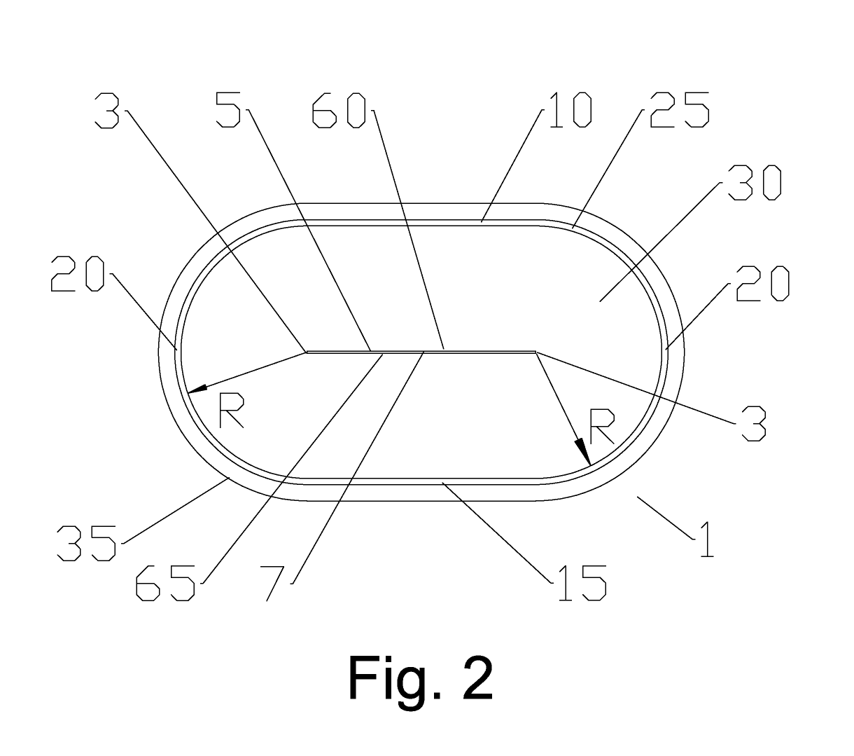

The dimensions/curvature of the edge sections 20 may be selected, for example, for ease of manufacture. Preferably, the edge sections 20 and any transition thereto from the top and bottom sections 10, 15 is generally smooth, without sharp angles or edges. As best shown in FIG. 2, the edge sections 20 may be provided as circular arcs with an arc radius R, with respect to each side of the inner conductor 5, equivalent to the spacing between each of the top and bottom sections 10, 15 and the inner conductor 5, resulting in a generally equal spacing between any point on the circumference of the inner conductor 5 and the nearest point of the outer conductor 25, minimizing outer conductor material requirements.

The desired spacing between the inner conductor 5 and the outer conductor 25 may be obtained with high levels of precision via application of a uniformly dimensioned spacer structure with dielectric properties, referred to as the dielectric layer 30, and then surrounding the dielectric layer 30 with the outer conductor 25. Thereby, the cable 1 may be provided in essentially unlimited continuous lengths with a uniform cross-section at any point along the cable 1.

The inner conductor 5 metallic strip may be formed as solid rolled metal material such as copper, aluminum, steel or the like. For additional strength and/or cost efficiency, the inner conductor 5 may be provided as copper-coated aluminum or copper-coated steel.

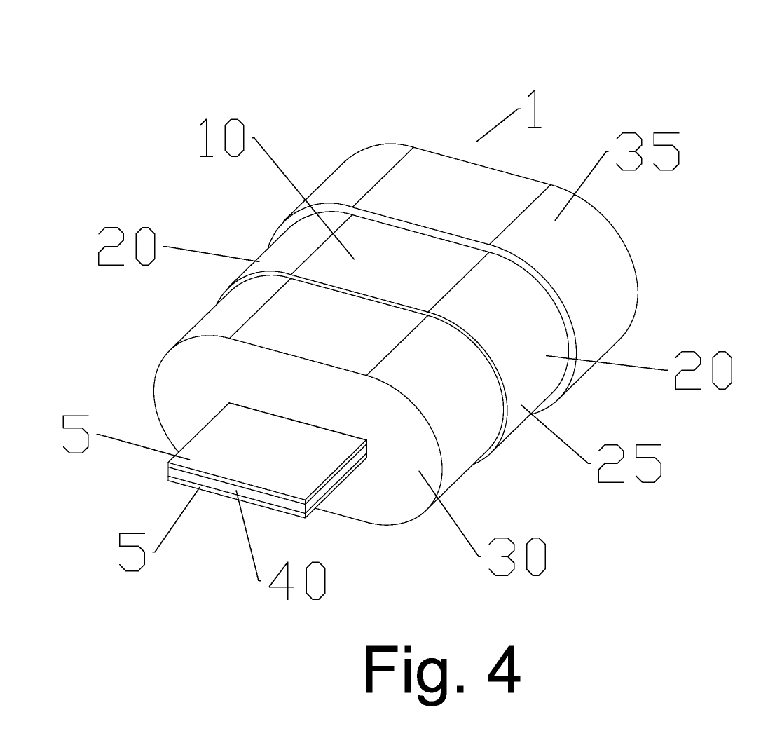

Alternatively, the inner conductor 5 may be provided as a substrate 40 such as a polymer and/or fiber strip that is metal coated or metalized, for example as shown in FIG. 4, including application of the thermally conductive material 32 (described in detail herebelow) to the substrate 40. One skilled in the art will appreciate that such alternative inner conductor configurations may enable further metal material reductions, thermal conductivity improvement and/or an enhanced strength characteristic enabling a corresponding reduction of the outer conductor strength characteristics.

The dielectric layer 30 may be applied as a continuous wall of plastic dielectric material around the outer surface of the inner conductor 5. The dielectric layer 30 may be a low loss dielectric material comprising a suitable plastic such as polyethylene, polypropylene, and/or polystyrene. The dielectric material may be of an expanded cellular foam composition, and in particular, a closed cell foam composition for resistance to moisture transmission. Any cells of the cellular foam composition may be uniform in size. One suitable foam dielectric material is an expanded high density polyethylene polymer as disclosed in commonly owned U.S. Pat. No. 4,104,481, titled “Coaxial Cable with Improved Properties and Process of Making Same” by Wilkenloh et al, issued Aug. 1, 1978, hereby incorporated by reference in the entirety. Additionally, expanded blends of high and low density polyethylene may be applied as the foam dielectric.

Although the dielectric layer 30 generally consists of a uniform layer of foam material, as described in greater detail herein below, the dielectric layer 30 can have a gradient or graduated density varied across the dielectric layer cross-section such that the density of the dielectric increases and/or decreases radially from the inner conductor 5 to the outer diameter of the dielectric layer 30, either in a continuous or a step-wise fashion. Alternatively, the dielectric layer 30 may be applied in a sandwich configuration as two or more separate layers together forming the entirety of the dielectric layer 30 surrounding the inner conductor 5.

To improve the thermal dissipation characteristics of the cable 1, the dielectric layer 30 may be provided utilizing a material with increased thermal conductivity characteristics. For example, the dielectric layer 30 may be formed from a base polymer infused with a thermally conductive material. The base polymer may be polyethylene, polypropylene, and/or polystyrene or the like as described herein above and the thermally conductive material provided as boron nitride particles, carbon fibers, ceramic particles and the like infused within a base polymer material. In one exemplary thermally conductive polymer composition, the thermally conductive filler includes 30 to 60% of a base polymer material, 25% to 50% of a first thermally conductive filler material, and 10 to 25% of a second thermally conductive filler material. An example of a commercially available thermally conductive material with suitable dielectric properties is CoolPoly® D5108 from Cool Polymers, Inc. of Warwick, R.I., which has a significantly improved thermal conductivity property of 10 W/mK. CoolPoly® D5108 has a dielectric constant, measured at one megahertz, of 3.7 while standard polyethelene typically has a dielectric constant around 2.3. In standard formulations, CoolPoly® D5108 may be a rigid material. One skilled in the art will appreciate that a blend of base polymer material, such as polyethelene or the like, and a thermally conductive material 32 wherein the base material is a majority component will have a trade off in thermal conductivity to obtain a flexibility characteristic and dielectric constant complementary to that of the base polymer material, depending upon the proportions selected. For purposes of the present specification, a thermally conductive material 32 is a material having a greater thermal conductivity characteristic than the respective materials described herein with respect to the dielectric layer 30 and jacket 35, respectively, depending upon the location on the cable 1 where the thermally conductive material 32 is applied.

The dielectric layer 30 may be bonded to the inner conductor 5 by a thin layer of adhesive. Additionally, a thin solid polymer layer and another thin adhesive layer may be present, protecting the outer surface of the inner conductor 5 (for example, as it is collected on reels during cable manufacture processing).

The outer conductor 25 is electrically continuous, entirely surrounding the circumference of the dielectric layer 30 to eliminate radiation and/or entry of interfering electrical signals. The outer conductor 25 may be a solid material such as aluminum or copper material sealed around the dielectric layer as a contiguous portion by seam welding or the like. Alternatively, helically wrapped and/or overlapping folded configurations utilizing, for example, metal foil and/or braided type outer conductor 25 may also be utilized.

If desired, a protective jacket 35 of polymer materials such as polyethylene, polyvinyl chloride, polyurethane and/or rubbers may be applied to the outer diameter of the outer conductor. The jacket 35 may comprise laminated multiple jacket layers to improve toughness, strippability, burn resistance, the reduction of smoke generation, ultraviolet and weatherability resistance, protection against rodent gnaw-through, strength resistance, chemical resistance and/or cut-through resistance.

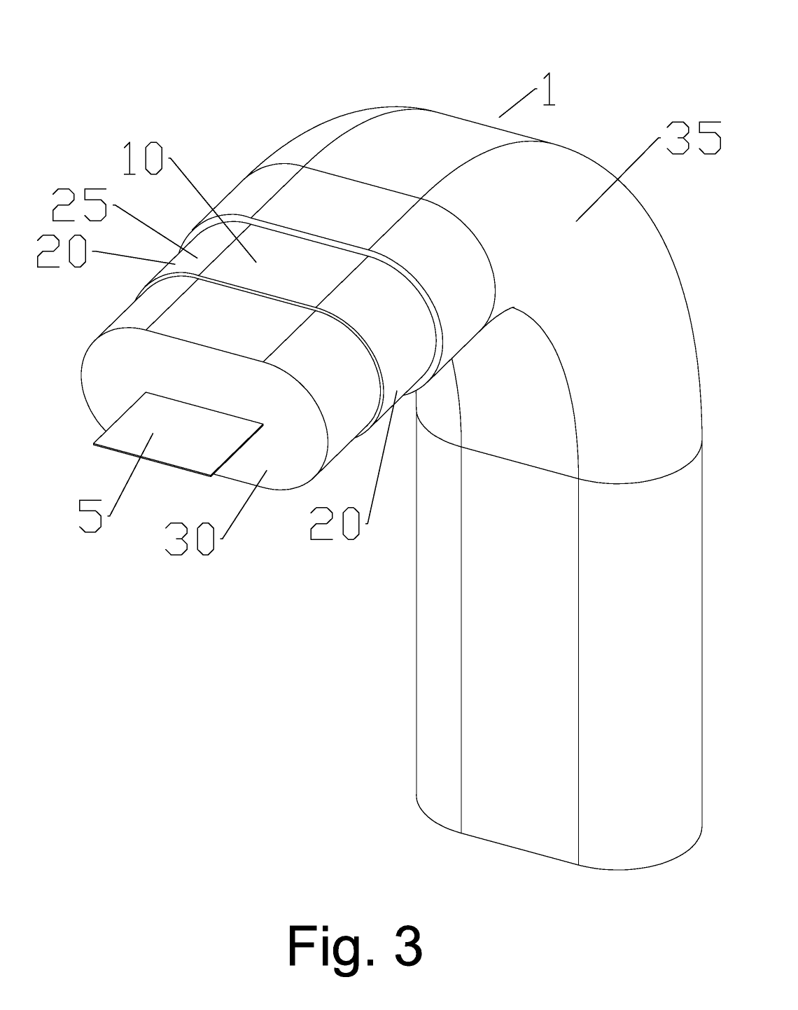

The flattened characteristic of the cable 1 has inherent bend radius advantages. As best shown in FIG. 3, the bend radius of the cable perpendicular to the horizontal plane of the inner conductor 5 is reduced compared to a conventional coaxial cable of equivalent materials dimensioned for the same characteristic impedance. Since the cable thickness between the top section 10 and the bottom section 15 is thinner than the diameter of a comparable coaxial cable, distortion or buckling of the outer conductor 25 is less likely at a given bend radius. A tighter bend radius also improves warehousing and transport aspects of the cable 1, as the cable 1 may be packaged more efficiently, for example provided coiled upon smaller diameter spool cores which require less overall space.

Electrical modeling of stripline-type RF cable structures with top and bottom sections with a width similar to that of the inner conductor (as shown in FIGS. 1-4) demonstrates that the electric field generated by transmission of an RF signal along the cable 1 and the corresponding current density with respect to a cross-section of the cable 1 is greater along the inner conductor edges 3 at either side of the inner conductor 5 than at a mid-section 7 of the inner conductor. Uneven current density generates higher resistivity and increased signal loss. Therefore, the cable configuration may have an increased attenuation characteristic, compared to conventional circular/coaxial type RF cable structures where the inner conductor circumferences are equal.

To obtain the materials and structural benefits of the stripline RF transmission cable 1 as described herein, the electric field strength and corresponding current density may be balanced by increasing the current density proximate the mid-section 7 of the inner conductor 5. The current density may be balanced, for example, by modifying the dielectric constant of the dielectric layer 30 to provide an average dielectric constant that is lower between the inner conductor edges 3 and the respective adjacent edge sections 20 than between a mid-section 7 of the inner conductor 5 and the top and the bottom sections 10,15. Thereby, the resulting current density may be adjusted to be more evenly distributed across the cable cross-section to reduce attenuation.

The dielectric layer 30 may be formed with layers of, for example, expanded open and/or closed-cell foam dielectric material, where the different layers of the dielectric material have a varied dielectric constant. The differential between dielectric constants and the amount of space within the dielectric layer 30 allocated to each type of material may be utilized to obtain the desired average dielectric constant of the dielectric layer 30 in each region of the cross-section of the cable 1.

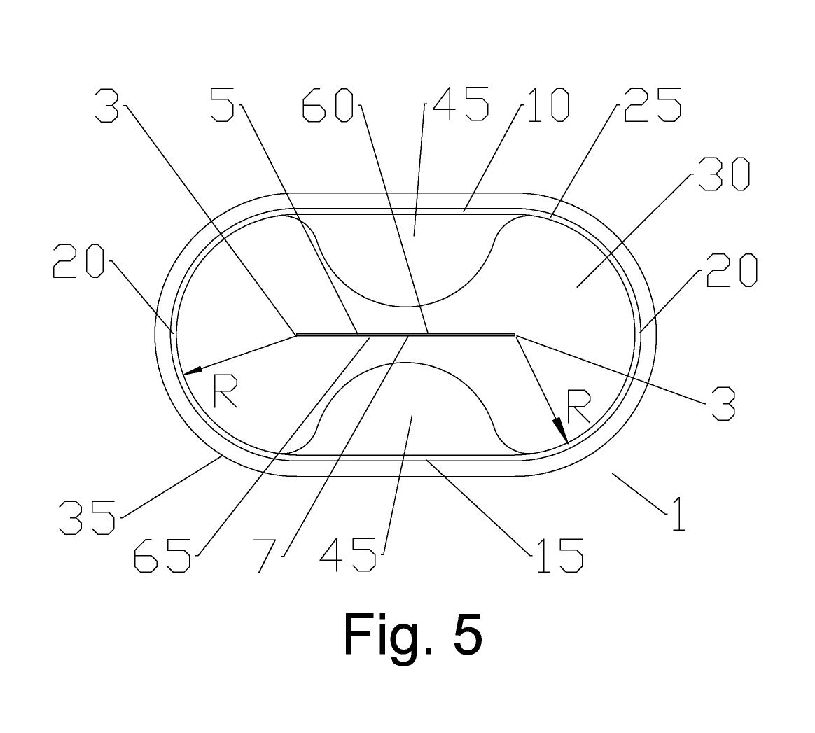

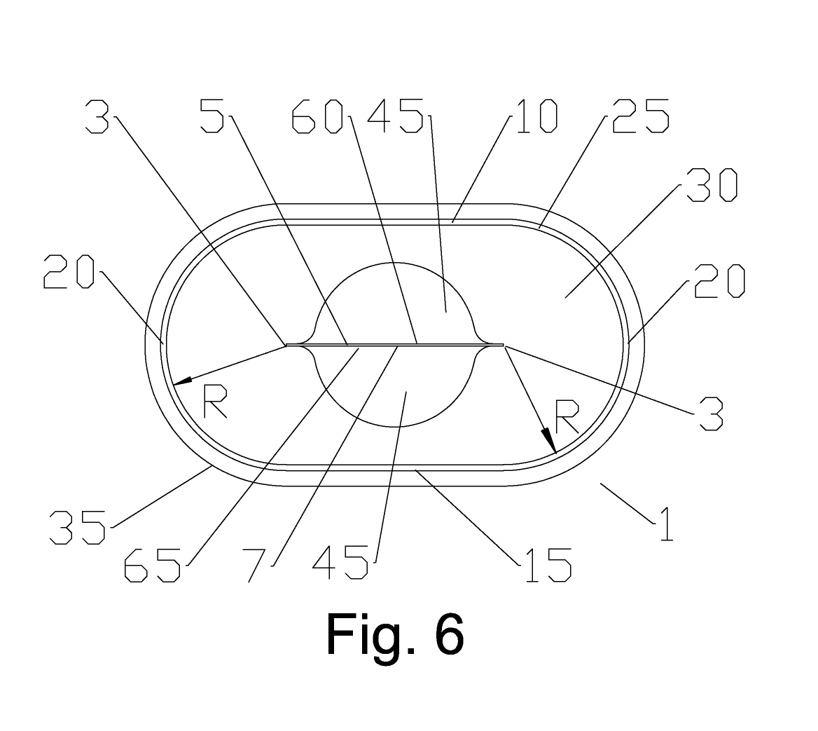

As shown for example in FIG. 5, a dome-shaped increased dielectric constant portion 45 of the dielectric layer 30 may be applied proximate the top section 10 and the bottom section 15 extending inward toward the mid-section 7 of the inner conductor 5. Alternatively, the dome-shaped increased dielectric constant portion 45 of the dielectric layer 30 proximate the inner conductor 5 may be positioned extending outward from the mid-section 7 of the inner conductor 5 towards the top and bottom sections 10,15, as shown for example in FIG. 6.

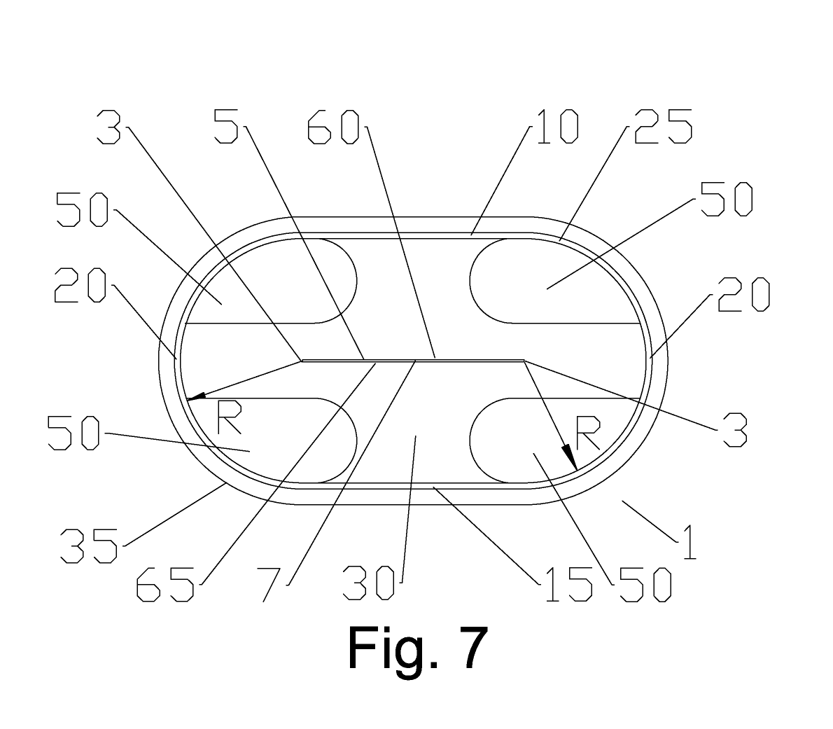

Air may be utilized as a low cost dielectric material. As shown for example in FIG. 7, one or more areas of the dielectric layer 30 proximate the edge sections 20 may be applied as a cavity 50 extending along a longitudinal axis of the cable 1. Such cavities 50 may be modeled as air (pressurized or unpressurized) with a dielectric constant of approximately 1 and the remainder of the adjacent dielectric material of the dielectric layer 30 again selected and spaced accordingly to provide the desired dielectric constant distribution across the cross-section of the dielectric layer 30 when averaged with the cavity portions allocated to air dielectric.

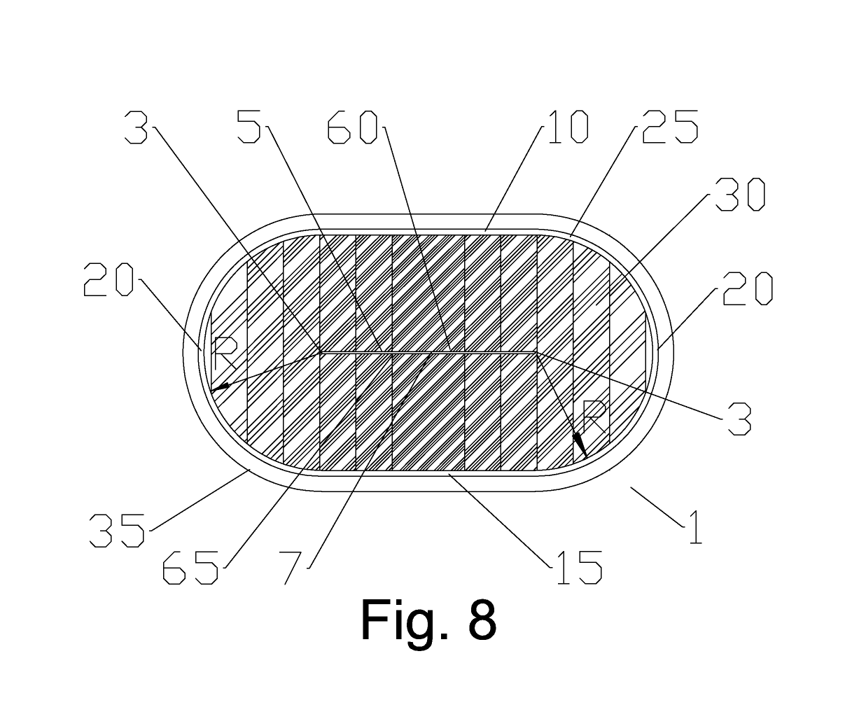

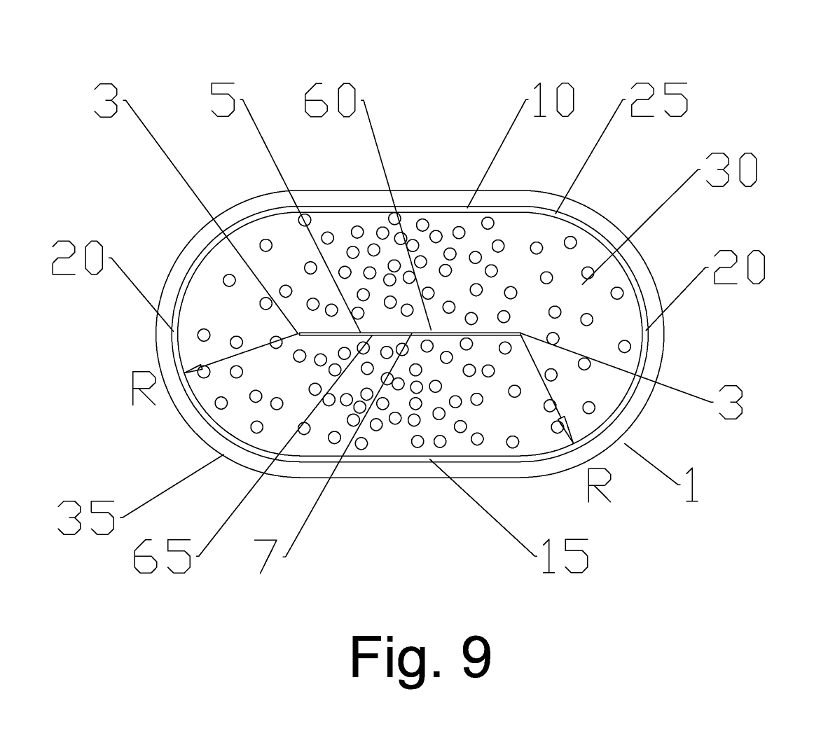

As shown for example in FIG. 8, multiple layers of dielectric material may be applied, for example, as a plurality of vertical layers aligned normal to the horizontal plane of the inner conductor 5, a dielectric constant of each of the vertical layers provided so that the resulting overall dielectric layer dielectric constant increases towards the mid-section 7 of the inner conductor 5 to provide the desired aggregate dielectric constant distribution across the cross-section of the dielectric layer 30. Alternatively, for example as shown in FIG. 9, the dielectric material may be applied as simultaneous high and low (relative to one another) dielectric constant dielectric material streams through multiple nozzles with the proportions controlled with respect to cross-section position by the nozzle distribution or the like so that a position varied mixed stream of dielectric material is applied to obtain a desired (e.g., generally smooth) gradient of the dielectric constant across the cable cross-section, so that the resulting overall dielectric constant of the dielectric layer 30 increases in a generally smooth gradient from the edge sections 20 towards the mid-section 7 of the inner conductor 5.

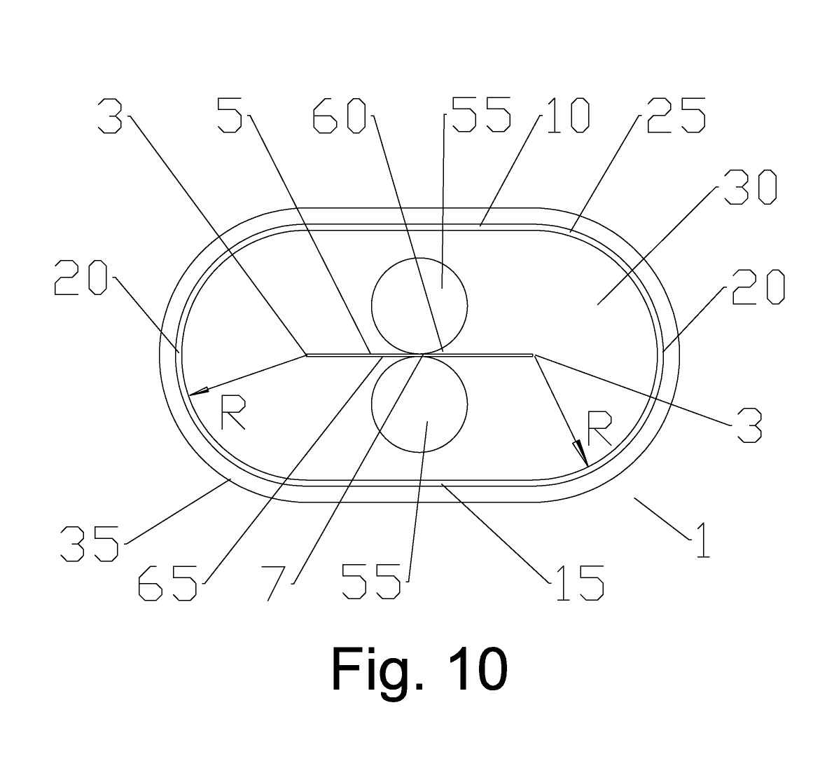

The materials selected for the dielectric layer 30, in addition to providing varying dielectric constants for tuning the dielectric layer cross-section dielectric profile for attenuation reduction, may also be selected to enhance structural characteristics of the resulting cable 1. For example, as shown in FIG. 10, the dielectric layer 30 may be provided with first and second dielectric rods 55 located proximate a top side 60 and a bottom side 65 of the mid-section 7 of the inner conductor 5. The dielectric rods 55, in addition to having a dielectric constant greater than the surrounding dielectric material, may be for example fiberglass or other high strength dielectric materials that improve the strength characteristics of the resulting cable 1. Thereby, the thickness of the inner conductor 5 and/or outer conductor 25 may be reduced to obtain overall materials cost reductions without compromising strength characteristics of the resulting cable 1.

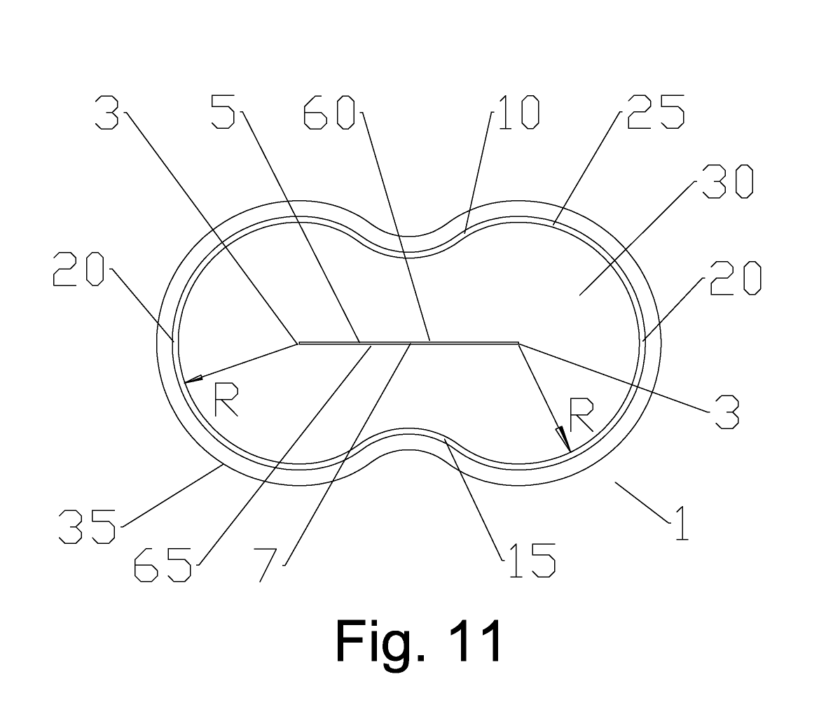

Alternatively and/or additionally, the electric field strength and corresponding current density may also be balanced by adjusting the distance between the outer conductor 25 and the mid-section 7 of the inner conductor 5. For example, as shown in FIG. 11, the outer conductor 25 may be provided spaced farther away from each inner conductor edge 3 than from the mid-section 7 of the inner conductor 5, creating a generally hour glass-shaped cross-section. The distance between the outer conductor 25 and the mid-section 7 of the inner conductor 5 may be less than, for example, 0.7 of a distance between the inner conductor edges 3 and the outer conductor 25 (at the edge sections 20).

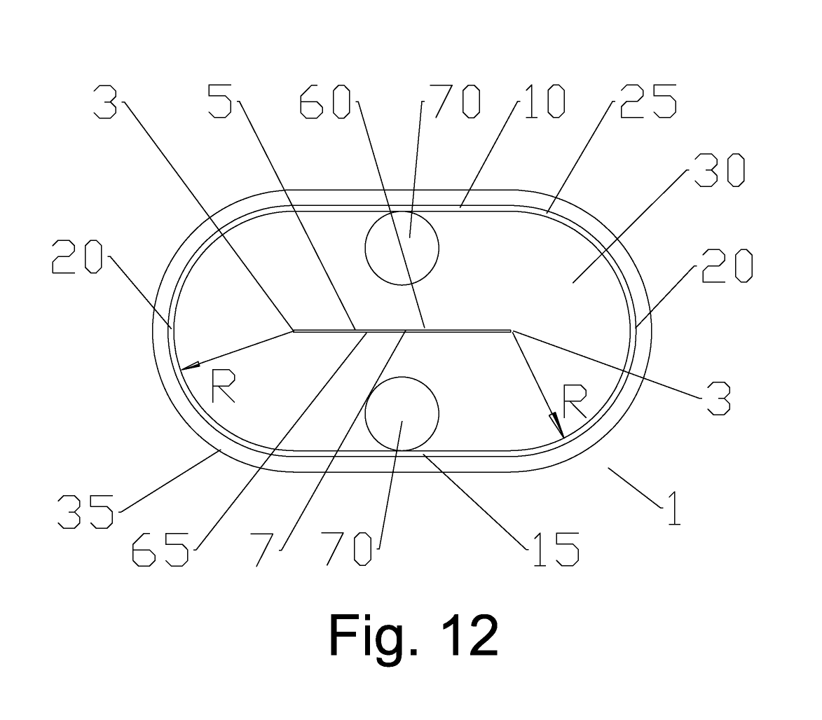

The dimensions may also be modified, for example as shown in FIG. 12, by applying a drainwire 70 coupled to the inner diameter of the outer conductor 25, one proximate either side of the mid-section 7 of the inner conductor 5. Because each of the drain wires 70 is electrically coupled to the adjacent inner diameter of the outer conductor 25, each drain wire 70 becomes an inwardly projecting extension of the inner diameter of the outer conductor 25, again forming the generally hour glass cross-section to average the resulting current density for attenuation reduction. As described with respect to the dielectric rods 55 of FIG. 10, the drain wires 70 may similarly increase structural characteristics of the resulting cable, enabling cost saving reduction of the metal thicknesses applied to the inner conductor 5 and/or outer conductor 25.

Although the thermally conductive material 32 described herein may be applied in a desired blend with the base polymer material to provide a dielectric layer 30 that is uniform across the cross-section and longitudinal extent, for example as shown in FIGS. 2 and 11, such application may degrade the flexibility characteristics of the resulting cable 1 and/or provide less than the desired level of thermal conductivity improvement in mix proportions resulting in acceptable flexibility characteristics.

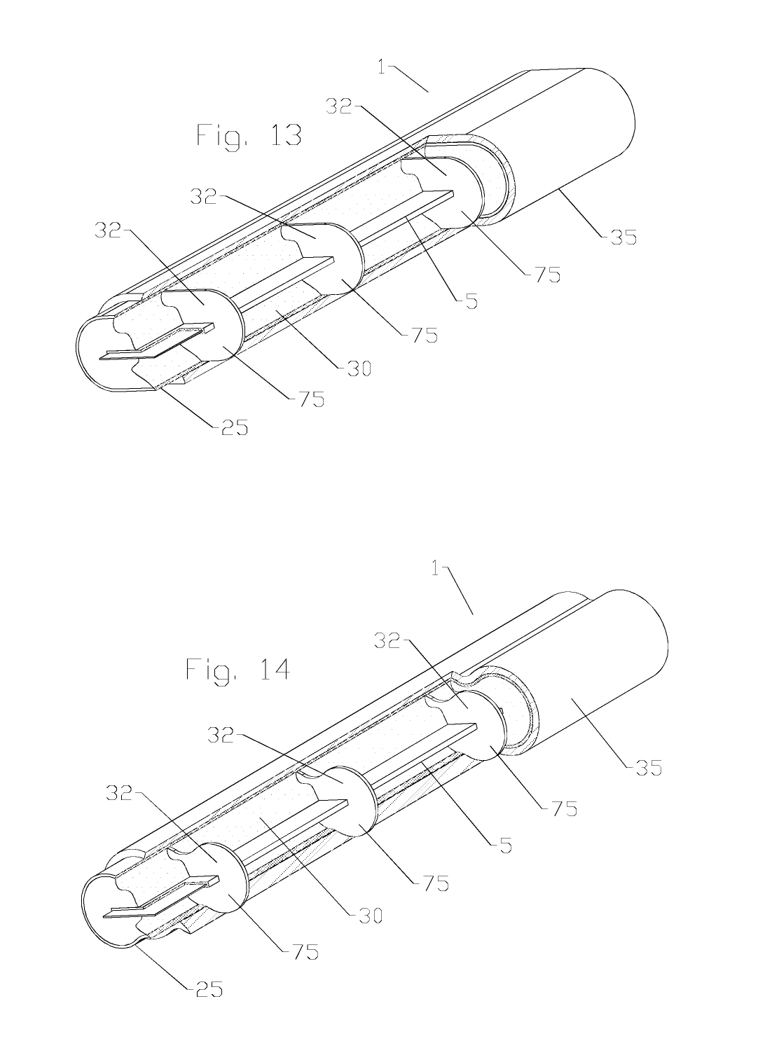

Alternatively, the thermally conductive material 32 may be applied, for example as shown in FIG. 13 or 14, concentrated in longitudinally-spaced apart bulkheads 75,. The bulkheads 75 may generated, for example, via an initial production step wherein the bulkheads 75 are molded upon the inner conductor 5, and then the dielectric layer 30 is applied to the inner conductor 5 with the bulkheads 75 already in position. Because the bulkheads 75 have a relatively narrow longitudinal extent and are longitudinally spaced along the cable 1, the bulk heads 75 may be formed with relatively high proportions of the thermally conductive material 32 without unacceptably reducing the flexibility characteristics of the resulting cable 1.

One skilled in the art will appreciate that the thermally conductive material 32 described herein above may be applied as the selected increased dielectric material distributed within the dielectric layer cross-section as the increased dielectric constant 45 and/or layer or stream of increased dielectric constant material according to FIGS. 5-9 to obtain dual benefits of increased thermal conductivity and improved current density distribution.

The thermally conductive material 32 may be applied, for example as shown in FIGS. 15-18, extending from the midsection 7 of the inner conductor 5 to the outer conductor 25, to form a continuous path of thermally conductive material 32 from the inner conductor 5 to the outer conductor 25.

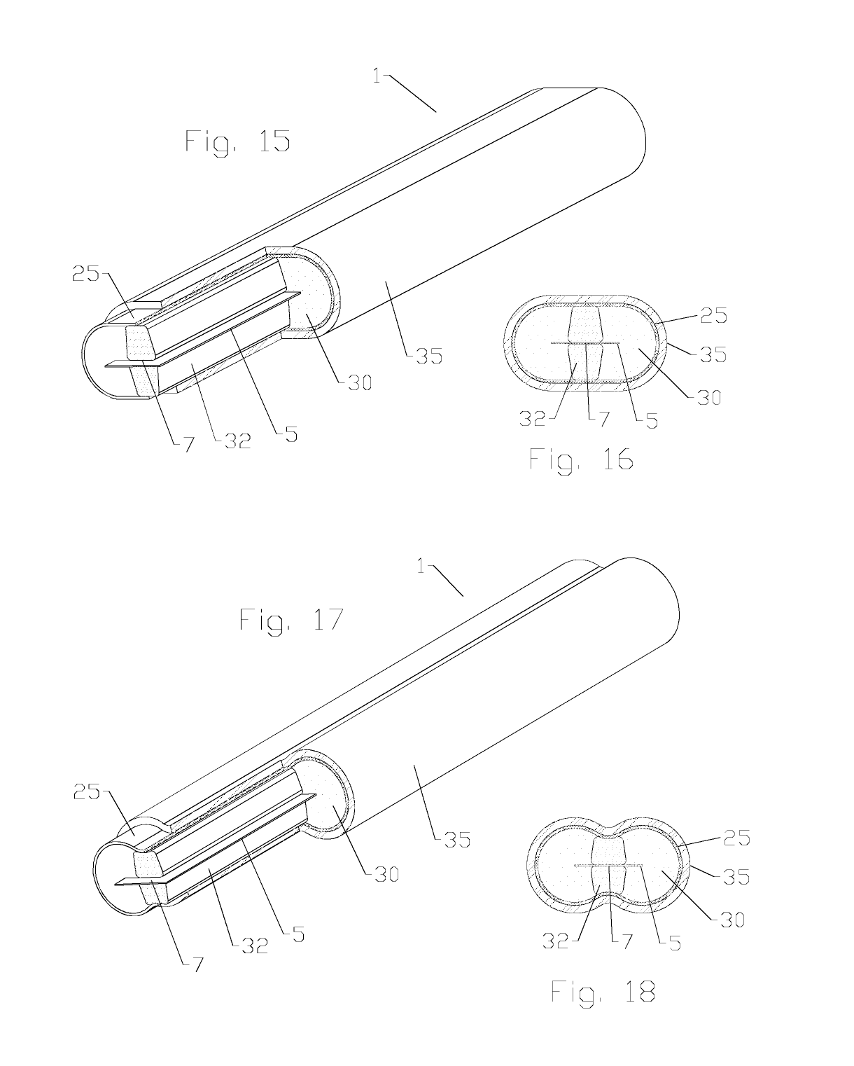

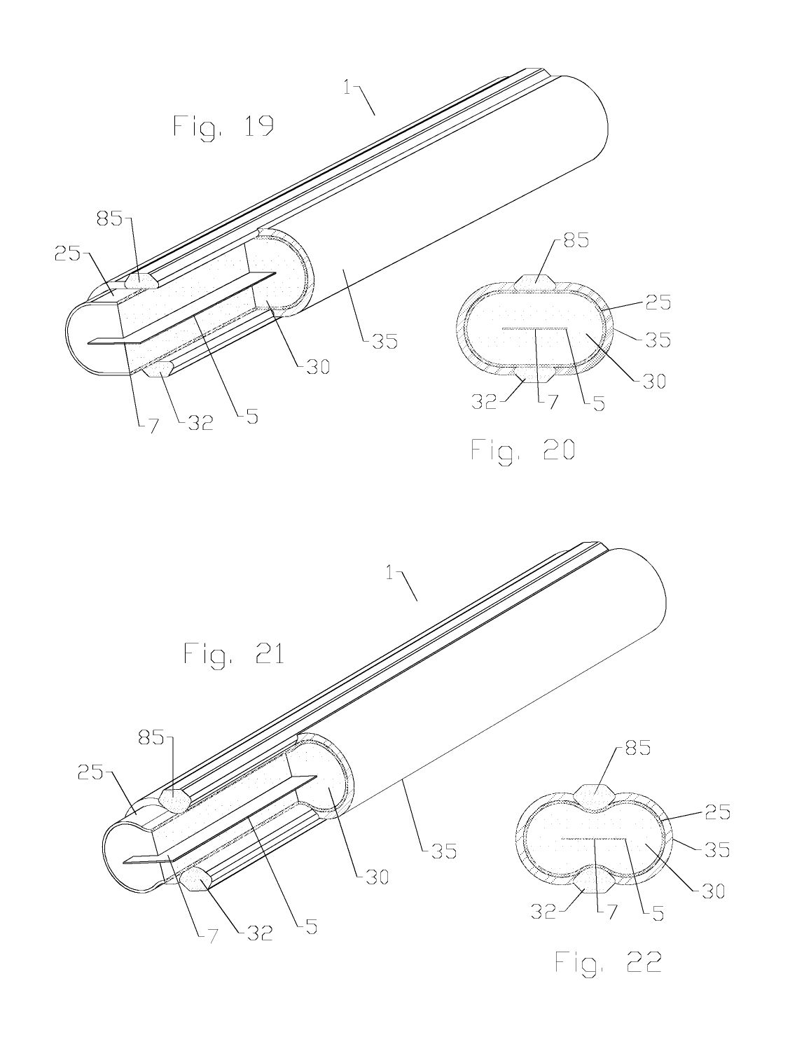

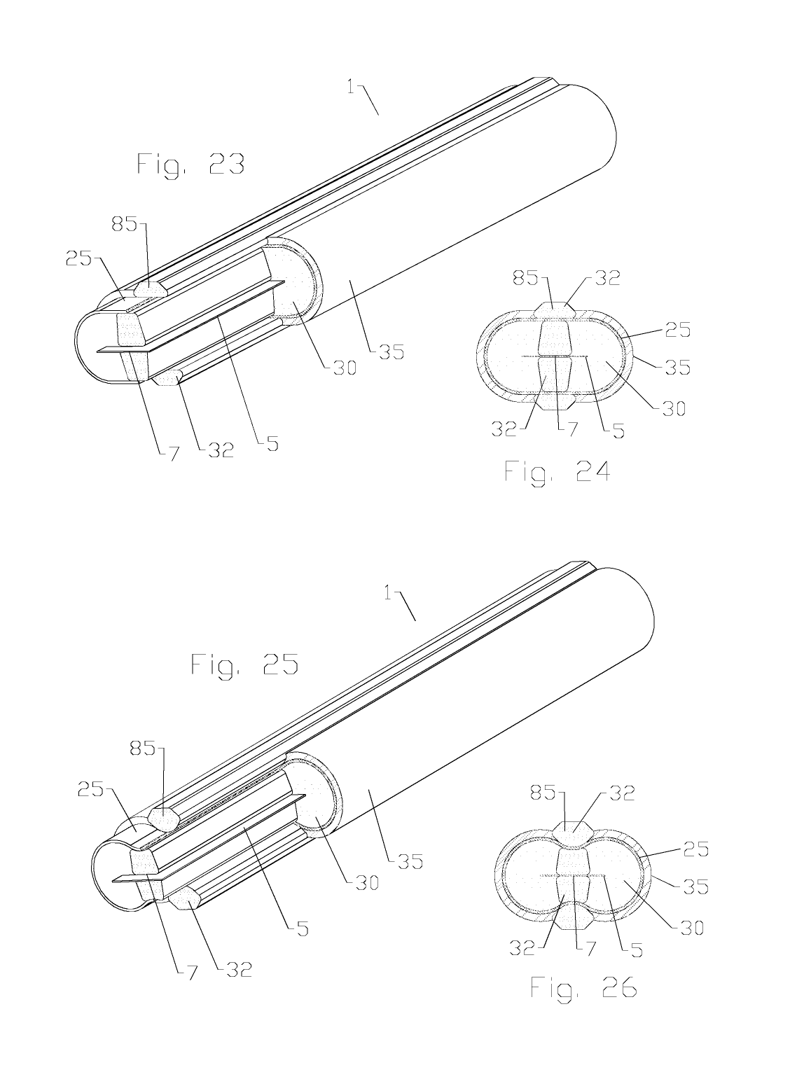

The polymer material of the jacket 35 may also function as an insulating layer, inhibiting thermal conduction out of the cable 1. Similar to embodiments wherein a portion of and/or the entire dielectric layer 30 has thermally conductive material 32 applied, the jacket 35 may also be blended with thermally conductive material 32 or thermally conductive material 32 applied concentrated in desired portions of the circumference of the jacket 35. For example, thermally conductive material 32 may be applied to the jacket 25 circumference aligned vertically with the midsection 7 of the inner conductor 5, as shown in FIGS. 19-26, via application of strips 85 of increased concentrations of the thermally conductive material 32.

Another dual functionality may be obtained by application of additional conductors 80 to the cable 1. The metal material of additional conductors 80, for example power or data conductors, in addition to providing further electrical power and/or data transmission functionality without requiring additional separate cables, operate with a hybrid cable as areas of high thermal conductivity/heat sinks to conduct heat from the cable 1. Additional conductors 80 may be applied, for example as shown in FIGS. 27-34, positioned within the dielectric layer 30 proximate the outer conductor 25 aligned with the horizontal plane of the inner conductor 5 or vertically aligned with the midsection 7 of the inner conductor 5.

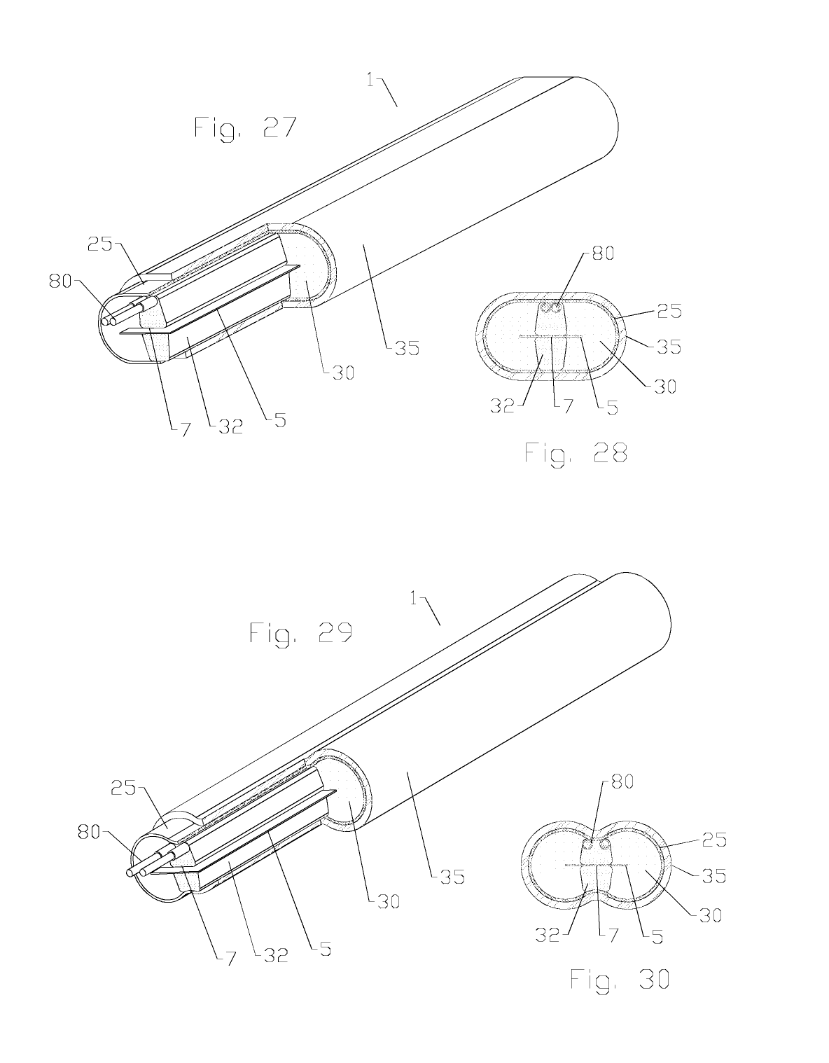

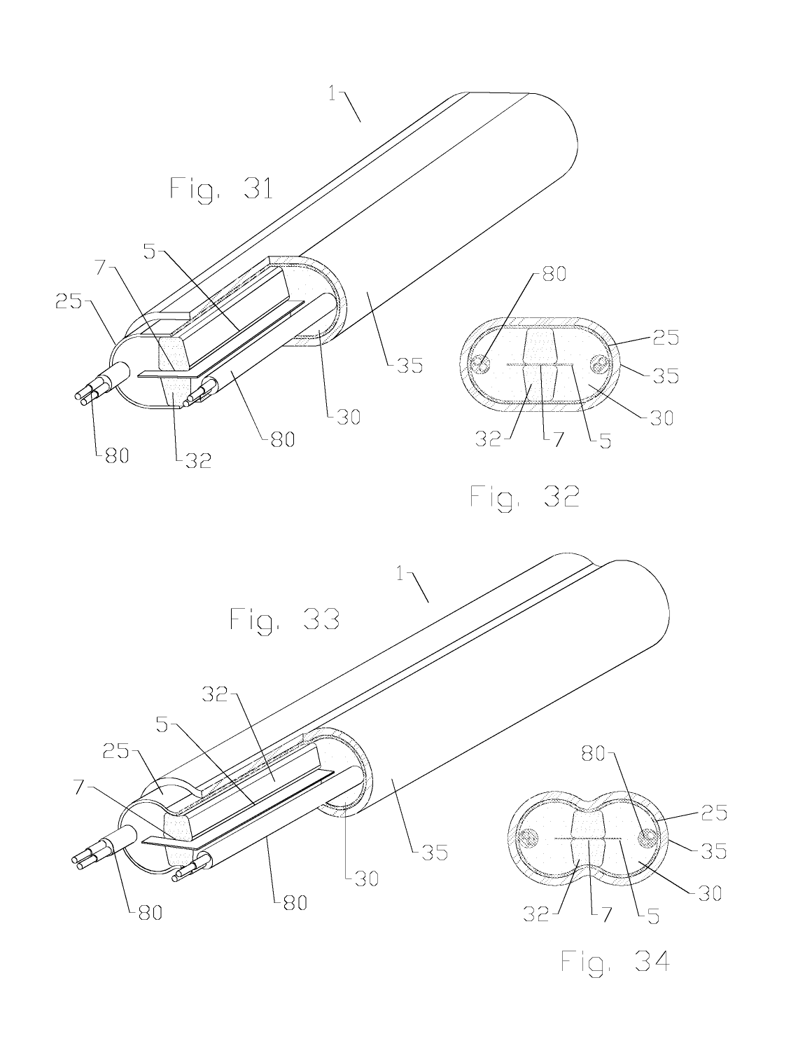

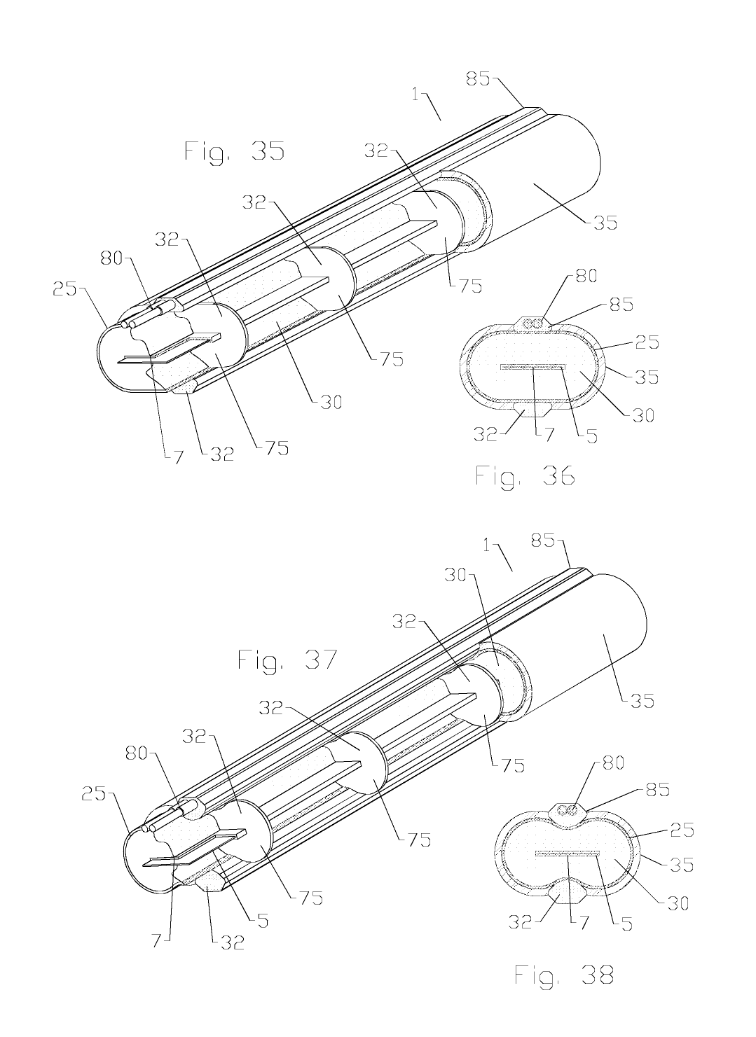

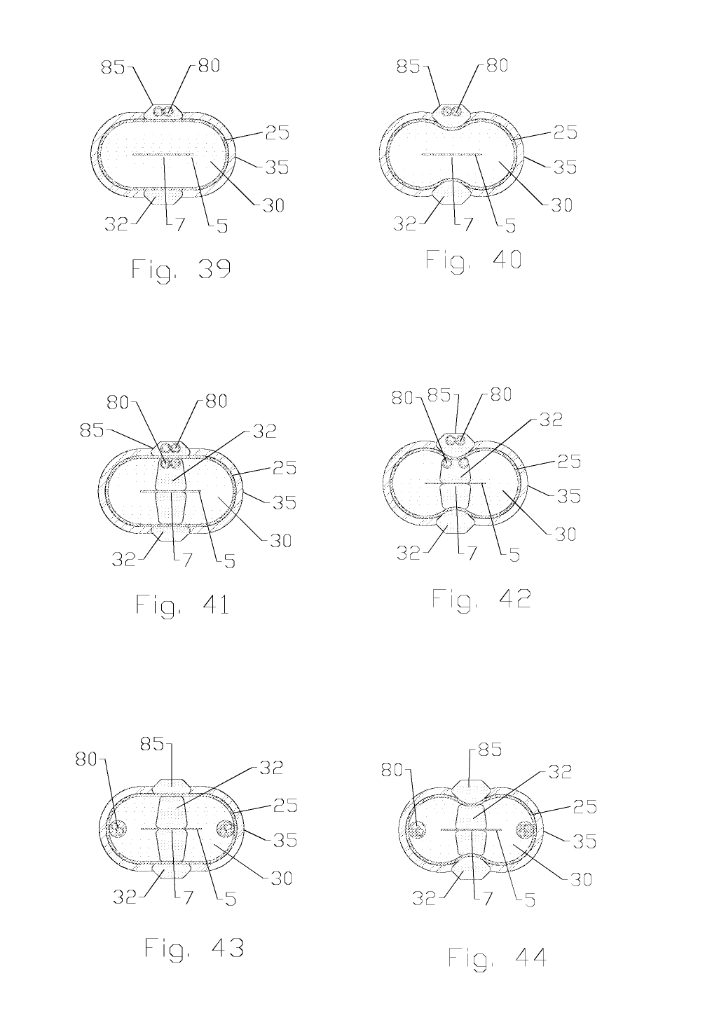

Alternatively and/or additionally, for example as shown in FIGS. 35-42, the additional conductors may be applied proximate the outer conductor 25 seated in the jacket 35, for example within a strip 85 of thermally conductive material 32 vertically aligned with the midsection 7 of the inner conductor 5.

Further, it should be recognized that application of the various thermal conductivity enhancements disclosed herein may be combined with one another to obtain the cumulative thermal conductivity benefit of each, for example as shown in FIGS. 43 and 44.

One skilled in the art will appreciate that the cable 1 has numerous advantages over a conventional circular cross-section coaxial cable. Because the desired inner conductor surface area is obtained without applying a solid or hollow tubular inner conductor, a metal material reduction of one half or more may be obtained. Alternatively, because complex inner conductor structures which attempt to substitute the solid cylindrical inner conductor with a metal coated inner conductor structure are eliminated, required manufacturing process steps may be reduced. Further, the flat inner conductor 5 configuration is particularly suited for thermal conductivity enhancement, compared to traditional circular cross-section coaxial cables as the increased dielectric constant of the thermally conductive material 32 and/or of additional conductors 80 also applied to the cable 5 may be configured to provide both an electrical performance enhancement and an improved thermal conductivity benefit.

Table of Parts

| | |
|---|---|
| 1 | cable |
| 3 | inner conductor edge |
| 5 | inner conductor |
| 7 | mid-section |
| 10 | top section |
| 15 | bottom section |
| 20 | edge section |
| 25 | outer conductor |
| 30 | dielectric layer |
| 32 | thermally conductive material |
| 35 | jacket |
| 40 | substrate |
| 45 | increased dielectric constant portion |
| 50 | cavity |
| 55 | dielectric rod |
| 60 | top side |
| 65 | bottom side |
| 70 | drain wire |
| 75 | bulkhead |
| 80 | additional conductor |
| 85 | strip |

Where in the foregoing description reference has been made to ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A thermally conductive stripline RF transmission cable, comprising:
a flat inner conductor extending between a pair of inner conductor edges;
the inner conductor surrounded by a dielectric layer; and
an outer conductor surrounding the dielectric layer;
the outer conductor provided with a flat top section and a flat bottom section; the top section and the bottom section transitioning to a pair of edge sections which interconnect the top section with the bottom section;
the dielectric layer provided as a base polymer and a thermally conductive material.

2. The cable of claim 1, wherein a thermal conductivity of the dielectric layer is lower between the inner conductor edges and the edge sections than between a midsection of the inner conductor and the top and the bottom sections.

3. The cable of claim 1, wherein a thermal conductivity of the dielectric layer is generally constant across a cross-section of the dielectric layer.

4. The cable of claim 1, wherein the thermally conductive material is concentrated in longitudinally spaced bulkheads of the dielectric layer.

5. The cable of claim 1, further including at least one additional conductor positioned within the dielectric layer, proximate the outer conductor.

6. The cable of claim 5, wherein the at least one additional conductor is situated aligned with a horizontal plane of the inner conductor.

7. The cable of claim 5, wherein the at least one additional conductor is situated vertically aligned with a midsection of the inner conductor.

8. A thermally conductive stripline RF transmission cable, comprising:
a flat inner conductor extending between a pair of inner conductor edges;
the inner conductor surrounded by a dielectric layer;
an outer conductor surrounding the dielectric layer;
the outer conductor provided with a flat top section and a flat bottom section; the top section and the bottom section transitioning to a pair of edge sections which interconnect the top section with the bottom section; and
a polymer jacket surrounding an outer surface of the outer conductor, the polymer jacket including thermally conductive material.

9. The cable of claim 8, further including at least one additional conductor seated in the polymer jacket.

10. The cable of claim 8, wherein the thermally conductive material of the polymer jacket is concentrated in longitudinal strips aligned vertically with a midsection of the inner conductor.

11. A thermally conductive stripline RF transmission cable, comprising:
a flat inner conductor extending between a pair of inner conductor edges;
the inner conductor surrounded by a dielectric layer; and
an outer conductor surrounding the dielectric layer;
the outer conductor provided spaced farther away from each inner conductor edge than from a midsection of the inner conductor;
the dielectric layer provided as a base polymer and a thermally conductive material.

12. The cable of claim 11, wherein a thermal conductivity of the dielectric layer is lower between the inner conductor edges and the outer conductor than between the midsection of the inner conductor and the outer conductor.

13. The cable of claim 11, wherein a thermal conductivity of the dielectric layer is generally constant across a cross-section of the dielectric layer.

14. The cable of claim 11, wherein the thermally conductive material is concentrated in longitudinally spaced bulkheads of the dielectric layer.

15. The cable of claim 11, further including at least one additional conductor positioned within the dielectric layer, proximate the outer conductor.

16. The cable of claim 15, wherein the at least one additional conductor is situated aligned with a horizontal plane of the inner conductor.

17. The cable of claim 15 wherein the at least one additional conductor is situated vertically aligned with a midsection of the inner conductor.

18. A thermally conductive stripline RF transmission cable, comprising:
a flat inner conductor extending between a pair of inner conductor edges;
the inner conductor surrounded by a dielectric layer; and
an outer conductor surrounding the dielectric layer;
the outer conductor provided spaced farther away from each inner conductor edge than from a midsection of the inner conductor; and
a polymer jacket surrounding an outer surface of the outer conductor, the polymer jacket including thermally conductive material.

19. The cable of claim 18, further including at least one additional conductor seated in the polymer jacket.

20. The cable of claim 18, wherein the thermally conductive material of the polymer jacket is concentrated in strips aligned vertically with a midsection of the inner conductor.
